(19) United States
(12) Patent Application Publication
(10) Pub. No.: US 2015/0328686 A1
(43) Pub. Date: Nov. 19, 2015

(54) METHOD OF MAKING A NOZZLE INCLUDING INJECTION MOLDING

(71) Applicant: 3M INNOVATIVE PROPERTIES COMPANY, Saint Paul, MN (US)

(72) Inventors: Paul A. Martinson, Maplewood, MN (US); Barry S. Carpenter, Oakdale, MN (US); David H. Redinger, Afton, MN (US); Scott M. Schnobrich, Stillwater, MN (US); Ryan C. Shirk, Mendota Heights, MN (US)

(21) Appl. No.: 14/652,595

(22) PCT Filed: Dec. 19, 2013
(86) PCT No.: PCT/US13/76321

§ 371 Date: Jun. 16, 2015

Related U.S. Application Data
(60) Provisional application No. 61/740,708, filed on Dec. 21, 2012.

(51) Int. Cl. B22F 3/22; B29C 33/38; B22F 5/10; B29C 45/26

(52) U.S. Cl. CPC B22F 3/225; B29C 45/2628; B29C 33/3842; B22F 5/10; B29K 2905/08; B29L 2031/737

(57) ABSTRACT

Methods of making fuel nozzles are described. More specifically, methods of making fuel nozzles including injection molding are described. The injection molding may include polymer injection molding, powder injection molding, or micro powder injection molding, including micro metal injection molding. The formation of microstructures in the described methods may use the selective exposure of a material capable of undergoing a multiphoton reaction.

### FIELD

The present disclosure relates to methods of making nozzles. More specifically, the present disclosure relates to methods of making nozzles that may be used as components of a fuel injector or a fuel injector system.

### BACKGROUND

In many combustion engines, fuel injectors are important to precisely control the mixture of fuel and air, ensuring an efficient burn with minimal residual hydrocarbons. To maximize efficiency and minimize emissions, reduction of unburned hydrocarbons may be achieved through careful design of the fuel injector system.

Central to the design and overall efficiency of a fuel injector system is the configuration of one or more fuel injector nozzles, which direct, control, and shape the spray of fuel into the combustion portion of the engine. Fuel injector nozzles are typically formed from processes into which are difficult to reliably incorporate precise design elements or complicated configurations, such as thin-gauge metal stamping. Other methods, such as forming a reverse-image nozzle tool, typically require multiple costly (both in money and time) manufacturing steps, such as electroforming each polymer pre-form stamped by the tool and further grinding or planarizing each pre-form to obtain through holes. There is a need for processes that minimize costly manufacturing steps while still allowing for precise control of nozzle shape and size.

### SUMMARY

In one aspect, the present disclosure describes a method of making a fuel injector nozzle. More specifically, the present disclosure describes a method including providing a first material capable of undergoing multiphoton reaction, forming a first microstructured pattern in the first material using a multiphoton process, replicating the first microstructured pattern in a second material different than the first material to make a first mold including a second microstructured pattern in the second material, and replicating the second microstructured pattern in a third material to make a second mold including a third microstructured pattern including a plurality of microstructures in the third material. Further, the present disclosure describes positioning a plate above the second mold proximate the peaks of the plurality of microstructures in the third material, injection molding a fourth material in the area above the second mold surrounding the third microstructured pattern and below the plate, and removing the plate and second mold, resulting in a fuel injector nozzle including the fourth material and further including a plurality of through holes.

In some embodiments, the third material may be different than the first and second materials. In other embodiments the third material may be the same materials as the second material. The fourth material may be the same as the third material, or may be different that the first, second and third materials. In some embodiments, replicating the first microstructured pattern in a second material includes electroforming the first microstructured pattern. In such an embodiment, the second material may be nickel or a nickel alloy. In some embodiments, the fourth material may be made up of a polymer, metal or ceramic. The first material may be made up of poly(methylmethacrylate), and/or may be a material capable of undergoing a two photon reaction, potentially a simultaneous two photon absorption. The microstructures described may, in some embodiments, be three-dimensional rectilinear bodies, or three-dimensional curvilinear bodies.

Additionally, the method described may further include the step of removing a remaining portion of the fourth material of the fuel injector nozzle to open the plurality of through holes. Such a step may be accomplished by backside grinding or EDM. Further steps to the process may include debinding the fuel injector, sintering the fuel injector, and applying a metal to a surface of the fuel injector nozzle.

In another aspect, the present disclosure describes a method of making a fuel injector nozzle including providing a first material capable of undergoing multiphoton reaction and forming a first microstructured pattern in the first material using a multiphoton process. Further, the method includes replicating the first microstructured pattern in a second material different than the first material to make a mold including a second microstructured pattern including a plurality of microstructures in the second material, positioning a plate above the mold proximate the peaks of the plurality of microstructures in the second material, injection molding a third material in the area above the mold surrounding the second microstructured pattern and below the plate, and removing the plate and mold, resulting in a fuel injector nozzle including the third material and further including a plurality of through holes.

In some embodiments, the third material may be different than the first and second materials. In other embodiments the third material may be the same materials as the second material. The method described may further include the step of removing a remaining portion of the third material of the fuel injector nozzle to open the plurality of through holes. Such a step may be accomplished by backside grinding or EDM. Further steps to the process may include debinding the fuel injector, sintering the fuel injector, and applying a metal to a surface of the fuel injector nozzle. In yet another aspect, the present disclosure describes a method of making a fuel injector nozzle including forming a mold by creating a microstructured pattern in a first material, the first microstructured pattern including a plurality of microstructures and positioning a plate above the first mold proximate the peaks of the plurality of microstructures in the mold. Additionally, the method includes injection molding a second material different than the first material in the area above the mold surrounding the microstructured pattern and below the plate and removing the plate and mold, resulting in a fuel injector nozzle including the second material and further including a plurality of through holes.

In some embodiments, creating a microstructured pattern may be accomplished by end milling. In other embodiments, creating a microstructured pattern may be accomplished by backside grinding or EDM. The method described may further include the step of removing a remaining portion of the second material of the fuel injector nozzle to open the plurality of through holes. Such a step may be accomplished by backside grinding or EDM. Further steps to the process may include debinding the fuel injector, sintering the fuel injector, and applying a metal to a surface of the fuel injector nozzle. In still yet another aspect, the present disclosure describes a method of making a fuel injector nozzle including providing a first material capable of undergoing multiphoton reaction and forming a first microstructured pattern in the first material using a multiphoton process. The method also includes replicating the first microstructured pattern in a second material different than the first material to make a tool including a second microstructured pattern in the second material, using the tool to form a third microstructured pattern including a plurality of microstructures that is the inverse of the second microstructured pattern in a metallic substrate to create a mold, positioning a plate above the mold proximate the peaks of the plurality of microstructures in the metallic substrate, injection molding a third material in the area above the mold surrounding the third microstructured pattern and below the plate, and removing the plate and mold, resulting in a fuel injector nozzle including the fourth material and further including a plurality of through holes.

In some embodiments, the tool may be an electrode. The tool may form a microstructured pattern in a metallic substrate by EDM. The method described may further include the step of removing a remaining portion of the third material of the fuel injector nozzle to open the plurality of through holes. Such a step may be accomplished by backside grinding or EDM. Further steps to the process may include debinding the fuel injector, sintering the fuel injector, and applying a metal to a surface of the fuel injector nozzle.

### BRIEF DESCRIPTION OF THE DRAWINGS

FIGS. 1A-1J are intermediate schematic cross-sectional elevation views of a method of making a nozzle.

FIGS. 2A-2H are intermediate schematic cross-sectional elevation views of another method of making a nozzle.

FIGS. 3A-3E are intermediate schematic cross-sectional elevation views of another method of making a nozzle.

### DETAILED DESCRIPTION

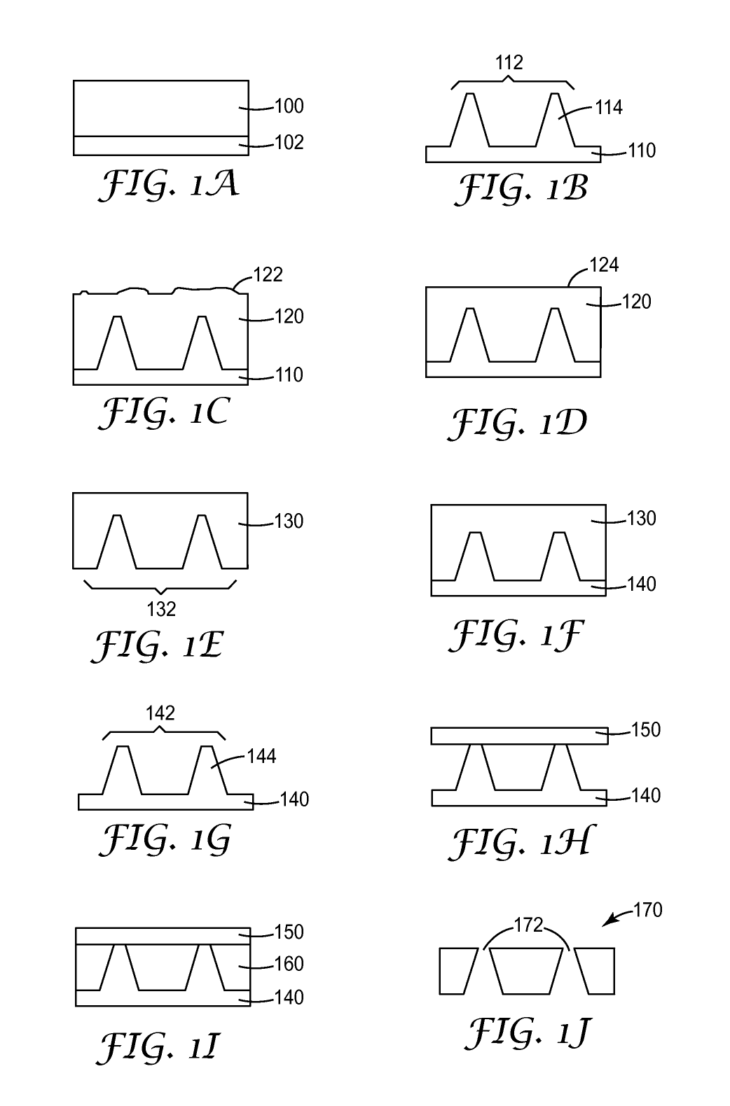

It should be understood that the term “nozzle” may have a number of different meanings in the art. In some specific references, the term nozzle has a broad definition. For example, U.S. Patent Publication No. 2009/0308953 A1 (Palestrant et al.) discloses an “atomizing nozzle” which includes a number of elements, including an occlude chamber 50. This differs from the understanding and definition of nozzle put forth herein. For example, the nozzle of the current description would correspond generally to the orifice insert 24 of Palestrant et al. In general, the nozzle of the current description can be understood as the final tapered portion of an atomizing spray system from which the spray is ultimately emitted; see, e.g., Merriam Webster's dictionary definition of nozzle (“a short tube with a taper or constriction used (as on a hose) to speed up or direct the flow of fluid.”) Further understanding may be gained by reference to U.S. Pat. No. 5,716,009 (Ogihara et al.). In this reference, again, fluid injection “nozzle” is defined broadly as the multi-piece valve element 10; see col. 4, lines 26-27 (“fuel injection valve 10 acting as fluid injection nozzle . . . ”). The current definition and understanding of the term “nozzle” as used herein would relate to first and second orifice plates 130 and 132 and potentially sleeve 138 (see FIGS. 14 and 15 of Ogihara et al.), for example, which are located immediately proximate the fuel spray. A similar understanding of the term “nozzle” to that described herein is used in U.S. Pat. No. 5,127,156 (Yokoyama et al.). There, the nozzle 10 is defined separately from elements of the attached and integrated structure, such as swirler 12 (see FIG. 1(II)). The above-defined understanding should be kept in mind when the term “nozzle” is referred to throughout the remained of the description and claims. Nozzle may also refer to a nozzle plate or array; i.e., a collection of through-holes on a single part. Similarly, a set of nozzles, nozzle arrays, or nozzle plates that are manufactured together and later cut or otherwise separated may also qualify under this definition of nozzle.

FIG. 1A is a cross-sectional schematic elevation view of a portion of material 100. Material 100 may be any suitable compound or substance. In some embodiments, one or more portions of material 100 may be capable of undergoing multiphoton reaction. The expression “capable of undergoing multiphoton reaction,” should be understood to mean that the material is capable of undergoing multiphoton reaction by simultaneously absorbing multiple photons. For example, material 100 may be capable of undergoing a two photon reaction by simultaneously absorbing two photons. Suitable materials and material systems that are capable of undergoing multiphoton reaction are described in, for example, U.S. Pat. No. 7,583,444 (DeVoe et al.), U.S. Pat. No. 7,941,013 (Marttila et al.), and PCT Publication No. WO 2009/048705 A1, entitled “Highly Functional Multiphoton Curable Reactive Species.”

In some cases, material 100 may be a photoreactive composition that includes at least one reactive species that is capable of undergoing an acid- or radical-initiated chemical reaction, and at least one multiphoton photoinitiator system. Reactive species suitable for use in the photoreactive compositions include both curable and non-curable species. Exemplary curable species include addition-polymerizable monomers and oligomers and addition-crosslinkable polymers (such as free-radically polymerizable or crosslinkable ethylenically-unsaturated species including, for example, acrylates, methacrylates, poly(methylmethacrylate), and certain vinyl compounds such as styrenes), as well as cationically-polymerizable monomers and oligomers and cationically-crosslinkable polymers (which are most commonly acid-initiated and which include, for example, epoxies, vinyl ethers, cyanate esters, etc.), and the like, and mixtures thereof. Exemplary non-curable species include reactive polymers whose solubility can be increased upon acid- or radical-induced reaction. Such reactive polymers include for example, aqueous insoluble polymers bearing ester groups that can be converted by photogenerated acid to aqueous soluble acid groups (for example, poly(4-tert-butoxycarbonyloxystyrene). Non-curable species also include the chemically-amplified photoresists.

The multiphoton photoinitiator system enables polymerization to be confined or limited to the focal region of a focused beam of light used to expose the first material. Such a system preferably is a two- or three-component system that includes at least one multiphoton photosensitizer, at least one photoinitiator (or electron acceptor), and, optionally, at least one electron donor.

Material 100 may be positioned on a substrate 102. Material 100 may be coated on substrate 102 using any suitable coating method based on the particular application. For example, material 100 may be coated on substrate 102 by flood coating. Other exemplary methods include knife coating, notch coating, reverse roll coating, gravure coating, spray coating, bar coating, spin coating, and dip coating.

Substrate 102 may be selected from a wide variety of films, sheets, and other surfaces (including silicon wafers and glass plates), depending upon the particular application and the method of exposure to be utilized. In some cases, substrate 102 is sufficiently flat so that material 100 has a uniform thickness. In some cases, material 100 may be exposed in bulk form. In such cases, substrate 102 may be excluded from the fabrication process. In some cases, such as when the process includes one more electroforming steps, substrate 102 may be electrically conductive or semiconductive.

Material 100 may be next selectively exposed to incident light having sufficient intensity to cause simultaneous absorption of multiple photons by the first material in the exposed region. The exposure can be accomplished by any method capable of providing light having a sufficient intensity. Exemplary exposure methods are described in commonly owned and assigned U.S. Patent Application Publication No. 2009/0099537, entitled “Process For Making Microneedles, Microneedle Arrays, Masters, And Replication Tools,” filed Mar. 23, 2007.

After selective exposure of material 100, the exposed material 100 is placed in a solvent to dissolve regions of higher solvent solubility. Exemplary solvents that can be used for developing the exposed first material include aqueous solvents such as, for example, water (for example, having a pH in a range of from 1 to 12) and miscible blends of water with organic solvents (for example, methanol, ethanol, propanol, acetone, acetonitrile, dimethylformamide, N-methylpyrrolidone, and the like, and mixtures thereof); and organic solvents. Exemplary useful organic solvents include alcohols (for example, methanol, ethanol, and propanol), ketones (for example, acetone, cyclopentanone, and methyl ethyl ketone), aromatics (for example, toluene), halocarbons (for example, methylene chloride and chloroform), nitriles (for example, acetonitrile), esters (for example, ethyl acetate and propylene glycol methyl ether acetate), ethers (for example, diethyl ether and tetrahydrofuran), amides (for example, N-methylpyrrolidone), and the like, and mixtures thereof.

FIG. 1B is a cross-sectional schematic elevation view of multiphoton master 110 which corresponds to the exposed and dissolved material 100. Multiphoton master 110 includes first microstructured pattern 114 which includes at least one first microstructure 114. The size of first microstructure 114 relative to the overall size and thickness of multiphoton master 110 is not necessarily to scale and is shown at the proportion in FIG. 1B for ease of illustration. First microstructured pattern 112 may have any suitable configuration of microstructures, including any pitch, shape, or size. In some embodiments, microstructure 114 may have a three-dimensional rectilinear shape or they may have a three-dimensional curvilinear shape. Each microstructure 114 may be the same or they may vary randomly, pseudorandomly, or in a gradient along one or more axes. Because, as shown by the end of FIGS. 1A-1J, microstructure 114 is important to part of the ultimate shape of the final nozzle, the formation of the multiphoton master 110 may require precise control.

In some embodiments, although not illustrated in FIGS. 1A-1J, multiphoton master 110 is metalized or otherwise made electrically conductive by coating the top surface of first microstructured pattern 114 with a thin electrically conductive seed layer. The conductive seed layer may include any electrically conductive material, including, for example, silver, chromium, gold, and titanium. In some cases, the seed layer may have a thickness that is less than about 50 nm, or less than about 40 nm, or less than about 30 nm, or less than about 20 nm.

Next, the seed layer is used to electroform multiphoton master 110, or, more specifically, first microstructured pattern 112, resulting in deposited material 120 formed over multiphoton master 110, as shown in FIG. 1C. The electroforming may use any suitable process variables, including the composition of the electroforming solution, the current density, plating time, and substrate speed. In some embodiments, the electroforming solution may contain an organic leveler, for example, sulfurized hydrocarbyl compounds, allyl sulfonic acid, polyethylene glycols of various kinds, and thiocarbamates, including bithiocarbamates or thiourea and their derivatives. Deposited material 120 may be any suitable material, including silver, passivated silver, gold, rhodium, aluminum, enhanced reflectivity aluminum, copper, cobalt, indium, nickel, chromium, tin, and alloys and combinations thereof. Deposited material 120 will generally be a different material than material 100.

The electroforming process may result in a rough or uneven electroformed surface 122 on one side of deposited material 120. If desired, the electroformed surface 122 may be ground or polished resulting in smooth surface 124 of deposited material 120 as shown in FIG. 1D. Suitable grinding methods may include surface grinding and mechanical milling.

In some embodiments, deposited material 120 may be directly deposited onto multiphoton master 110 without first coating first microstructured pattern 112 with a seed layer. Suitable processes that omit this step include, for example, sputtering and chemical vapor deposition. In other words, deposited material 120 need not be electroformed.

FIG. 1E shows mold 130 (essentially corresponding to deposited material 120 in FIG. 1D) removed or decoupled from multiphoton master 110. Removing or decoupling mold 130 may in some embodiments be able to be done by hand. In some applications it may be desirable to perform the grinding or polishing step illustrated as being performed between FIG. 1C and FIG. 1D after mold 130 is removed from multiphoton master 110 instead. Multiphoton master 110 leaves imprints in mold 130 which form second microstructured pattern 132. Second microstructured pattern generally corresponds to a negative replica of first microstructured pattern 112. Because, in some embodiments, mold 130 is formed by an electroforming process, mold 130 may have desirable physical characteristics inherited from the metal used such a durability and wear resistance.

FIG. 1F depicts mold 130 used to form bottom plate 140. Bottom plate 140 may be formed from any suitable material including a metallic, ceramic, or polymeric substrate, and may be selected for physical properties, such as durability and a high melting or glass transition temperature to withstand or maintain form throughout subsequent processing steps. The bottom plate material may be different than that of both material 100 and deposited material 120. In other embodiments, the bottom plate material may be the same as the deposited material 120.

Bottom plate 140 may be imprinted with or otherwise caused to conform to the patterned surface of mold 130 (corresponding to second microstructured pattern 132 in FIG. 1E) through any suitable method, including, for example, a cast and cure method or injection molding. In some embodiments, mold 130 may function as a tool or electrode in order to replicate second microstructured pattern 132 in bottom plate 140 through electrical discharge machining (EDM). Mold 130 may be used multiple times to form the full extent of bottom plate 140, for example, if bottom plate 140 was desired to be twice the length of mold 130, mold 130 may be used twice to form two adjacent microstructured patterns, and so on. Similarly, mold 130 may be used to only form a pattern in a portion of bottom plate 140; in other words, it may be desirable in some applications to form a microstructured pattern on less than the entirety of bottom plate 140.

FIG. 1G depicts bottom plate 140 after being removed or otherwise decoupled from mold 130. Bottom plate includes third microstructured pattern 142, which should be substantially identical to first microstructured pattern 112 and substantially a negative of second microstructured pattern 132. Third microstructured pattern 142 includes one or more of peak 144 which may be substantially identical to microstructure 114 of first microstructured pattern 112 created on multiphoton master 110 in FIG. 1B. In practice, slight variations between microstructure 114 and peak 144 may be introduced by the manufacturing process.

FIG. 1H shows bottom plate 140 and top plate 150. Top plate 150 may be any suitable material and any suitable shape and size. In some embodiments, top plate 150 may be the same material as bottom plate 140. Top plate 150 may also be formed from a metal or metal alloy, such as steel. In some embodiments, the dimensions of top plate 150 may be selected so that the plate is wear-resistant and durable through repeated use. Top plate 150 may be positioned proximate the peaks of bottom plate 140 and in some embodiments the two may be in contact. In some embodiments, top plate 150 may have a shaped, structured, or micropatterned surface. Bottom plate 140 may be referred to as the mold insert.

FIG. 1I depicts the injection molding step. Injected material 160 fills cavities between bottom plate 140 and top plate 150. It will be apparent to one skilled in the art that the two-dimensional representation of FIG. 1I is for ease of illustration, and the area between bottom plate 140 and top plate 150 may represent a three-dimensional volume. In other words, even though the middle cavity between the peaks of bottom plate 140 appears to be isolated, there may be channels—although not visible in two dimensions—that allow injected material 160 to fill the otherwise apparently isolated space.

FIG. 1I is merely a schematic representing an injection molding step and may include other components necessary for this process, including, for example, sidewalls, injection gates, appropriate input lines, and heating elements necessary to achieve the appropriate flow properties from the resin. Injected material 160 flows into the cavities formed between bottom plate 140 and top plate 150, which may be kept at or below the temperature where injected material 160 forms a sufficiently rigid part. Suitable parameters of the injection molding process, such as carefully controlling pressure to completely fill the volume between the plates.

Injected material 160 may be any material and may depend on the process used in conjunction with injecting the material. For example, the injection molding step may be polymer injection molding. Correspondingly, injected material 160 may be partially or entirely a polymer, polymeric resin, or a fluorinated polymer. The material may be selected for its rheological properties, including glass transition temperature and melting point.

In some embodiments, the injection molding step may include a powder injection molding step such as metal injection molding (MIM). Injected material 160 in this process may be a compound of both metal powder and a binder which may include several polymeric substances. The metal powder and binder are homogenized and subsequently heated, injected into a die or mold in similar fashion to standard polymeric injection molding and cooled to shape the compound to the desired form. This creates what may be referred to as a “green” part. The binder, while required for the injection molding step, may not be desired in the final molded part. In this case, a debinding step is required, where the molded green part is heated following a specific and carefully controlled temperature profile to eliminate the binder by thermal degradation. In some embodiments, the debinding may be done by dissolving the binder with an organic solvent or it may be done by providing an atmosphere containing a catalyst. After the binder is eliminated, the part is sintered. Sintering requires heating—though below the melting point of the metal—to increase the density of the molded part through atomic diffusion. In some cases, sintering may achieve better than 90%, 95%, 97% or 99% density with respect to the theoretical maximum.

In some embodiments, the injection molding step may include micro metal injection molding (μMIM). Micro metal injection molding is largely similar to convention metal injection molding, however, due to the smaller feature size (generally measured in tens or hundreds of microns), smaller particle size for the metal powder is required in conjunction with more precise control of the mold formation process. Several techniques described herein to form a mold with precise feature control may be advantageously used in conjunction with a micro metal molded injection process, such as, for example, a multiphoton exposure process. A related technique, micro ceramic injection molding (μCIM) (where ceramic powder instead of metal powder is used) may be advantageous in some applications, particularly due to the ability to achieve smaller powder grain sizes. Smaller powder grain sizes may increase the ability to reproduce extremely intricate features with enhances fidelity. The generic term for both μMIM and μCIM is micro powder injection molding (μPIM).

Injected material 160 may be the same or similar to that of the bottom plate material. However, in some embodiments, injected material 160 will be a different material than material 100, deposited material 120 and the material of bottom plate 140.

The completed part is shown in FIG. 1J. Due to the shape of bottom plate 140 and top plate 150, nozzle array 170 may include one or more through holes 172. Once again, FIG. 1J is a two-dimensional cross-sectional representation of a three-dimensional part: while nozzle array 170 appears to be in three parts the array is likely connected in other cross-sections. Because through holes 172 are related to the microstructured patterns used elsewhere in the process, including first microstructured pattern 112 on multiphoton master 110, precise control over the shape and profile of through holes 172 may be achieved by precise control of each microstructure 114. In some embodiments, post-formation processing may be desirable, such as backside grinding or EDM to open through holes 172 or coating or applying a metal to the surface of nozzle array 170 through any suitable process to incorporate desirable properties such as chemical resistance, abrasion resistance, or anti-fouling.

Notably, because the injection molding step may be rapidly and reliably repeated, producing a high volume of parts is not problematic because the high volume steps (that is, the steps that need to be performed for each part) are aligned with less time-consuming operations. Additionally, methods described herein may contain as few as one high volume step, as opposed to conventional processes where several steps have to be performed for each part. This efficiency of the described methods may save time and cost over conventional processes. For example, instead of electroforming each part, an electroforming step may be performed only once yet result in many parts, resulting in volume time and cost savings. Similarly, in some embodiments, the injection molded part needs no further grinding to open through holes, as opposed to conventional processes where each part needs to be grinded.

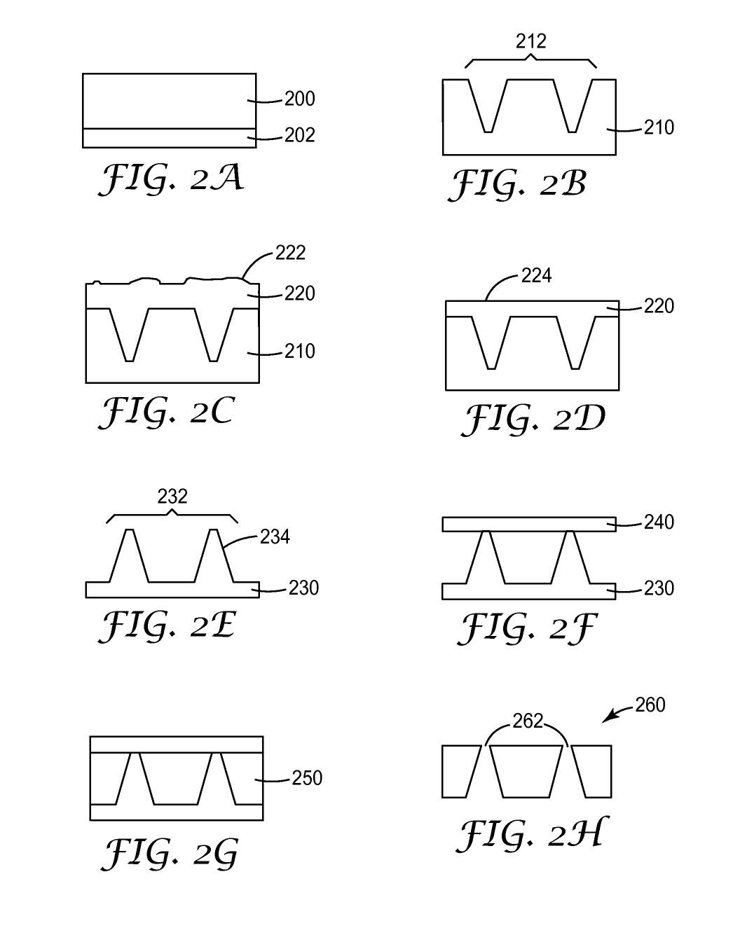

FIGS. 2A-2H are intermediate schematic cross-sections illustrating another method of making a nozzle. To avoid redundancy, the accompanying description to FIGS. 1A-1J is not restated for FIGS. 2A-2H but the corresponding description may be assumed to apply to corresponding steps. FIG. 2A corresponds to FIG. 1A, including material 200 (corresponding to material 100 of FIG. 1A) and substrate 202 (corresponding with substrate 102 of FIG. 1A). The material and substrate can include any materials, including, as in the previously described method, a material capable of undergoing a multiphoton reaction.

After material 200 is selectively exposed to suitable radiation and dissolved, multiphoton master 210 including first microstructured pattern 212 is created, as depicted in FIG. 2B. Note that first microstructured pattern 212 is essentially a negative of first microstructured pattern 112 in FIG. 1B.

Multiphoton master 210 is then seeded and electroformed with deposited material 220, which may form a rough surface 222, as shown in FIG. 2C. Deposited material 220 may be any material applied under any process conditions including those described above in conjunction with FIG. 1C. Rough surface 222 may be ground or polished to form smooth surface 224 of deposited material 220 as shown in FIG. 2D.

FIG. 2E shows bottom plate 230 (corresponding essentially to deposited material 220 with smooth surface 224 in FIG. 2D removed from multiphoton master 210). Bottom plate 230 includes second microstructured pattern 232 which is substantially a negative of first microstructured pattern 212. Second microstructured pattern 232 includes microstructure 234. Note that the negative process illustrated in FIGS. 2A-2H (so named because the initial multiphoton master is a negative of the final plate) generates a bottom plate from deposited material, while the positive process illustrated in FIGS. 1A-1J (so named because the initial multiphoton master is substantially the same as the final plate) uses an intermediate mold to generate a bottom plate. Each approach may be advantageous depending on application and manufacturing process concerns.

FIG. 2F shows top plate 240 positioned proximate the peaks of bottom plate 230. Top plate may again be any suitable material, including steel, and it may be any suitable size or dimension. The terms top and bottom are used in this application for convenience of illustration and explanation and are not meant to be limiting characteristic of the two plates, which may be oriented differently depending on the application.

FIG. 2G depicts the injection molding step which may be the same or different as the step described in the description corresponding to FIG. 1I. As for the previously described method, injected material 250 may include any suitable polymer, metal powder, ceramic, or blend thereof, and the injection molding step may include conventional injection molding or powder injection molding, including metal injection molding, micro metal injection molding, or micro ceramic injection molding.

The finished nozzle array 260 is shown in FIG. 2H, including through holes 262. Nozzle array 260 corresponds to nozzle array 170 of FIG. 1J, illustrating that identical, substantially identical, or at least similar parts may be produced with either method.

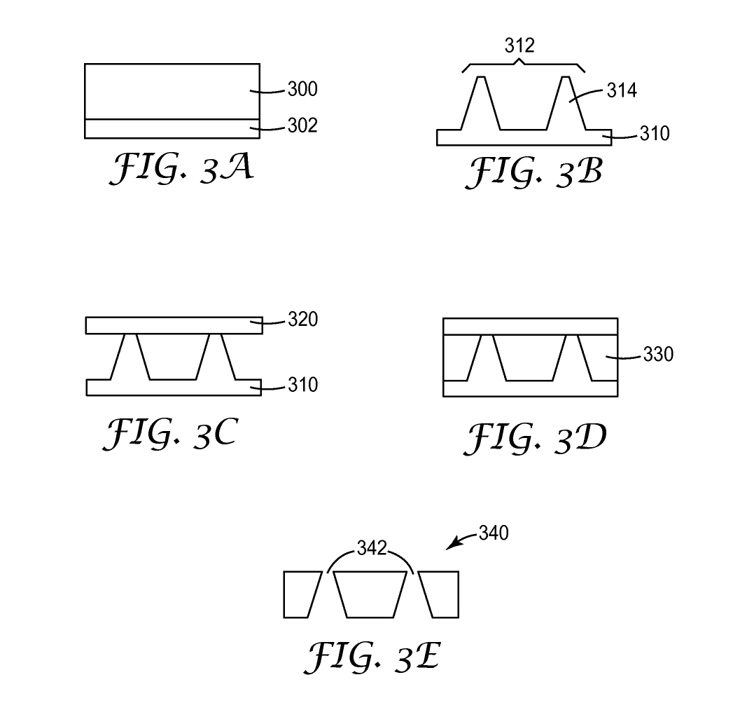

FIGS. 3A-3E depict intermediate schematic cross-sections of yet another method of making a fuel injector nozzle. As for FIGS. 2A-2H, detailed descriptions of similar, previously explained processing steps are not presented again in full but may be assumed to apply unless indicated otherwise.

FIG. 3A depicts a portion of material 300 positioned atop substrate 302. Material 300 may be any suitable material or combination of materials. Material 300, however, is not selected for its ability to undergo a multiphoton reaction, and correspondingly is not selectively exposed to light. Instead, material 300 should be a substance that may be suitable for use as a bottom plate in an injection molding die. Between FIGS. 3A and 3B, material 300 may be shaped or formed with any conventional method, such as end milling, EDM, grinding, embossing, or the like, resulting in bottom plate 310 as depicted in FIG. 3B. In some embodiments, bottom plate 310 may be directly generated from a process such as 3D printing, where layers of material are deposited in order to form a desired part. Bottom plate 310 has microstructured pattern 312 on one side which includes microstructure 314. This pattern and set of microstructures may be any suitable size, shape, and pitch or configuration. FIG. 3C depicts bottom plate 310 with top plate 314 placed proximate the peaks of the bottom plate.

FIG. 3D illustrates the injection molding step which may be the same or similar to those described in the description corresponding to either FIG. 2G or FIG. 1I. As in those cases, the injection molding step may include conventional polymer injection molding, powder injection molding, or micro powder injection molding, including micro metal injection molding and micro ceramic injection molding.

FIG. 3E shows the final part after removed from the injection molding die. Nozzle array 340 includes through holes 342 which may have any suitable geometry to suitably direct and control fuel spray. Nozzle array 340 corresponds to both nozzle array 260 of FIG. 2H and nozzle array 170 of FIG. 1J, demonstrating that the method may achieve substantially the same final part as the other two general approaches described herein.

### VARIOUS EXEMPLARY EMBODIMENTS

1. A method of making a fuel injector nozzle, comprising:

providing a first material capable of undergoing multiphoton reaction;

forming a first microstructured pattern in the first material using a multiphoton process;

replicating the first microstructured pattern in a second material different than the first material to make a first mold comprising a second microstructured pattern in the second material;

replicating the second microstructured pattern in a third material to make a second mold comprising a third microstructured pattern comprising a plurality of microstructures in the third material;

positioning a plate above the second mold proximate the peaks of the plurality of microstructures in the third material;

injection molding a fourth material in the area above the second mold surrounding the third microstructured pattern and below the plate; and

removing the plate and second mold, resulting in a fuel injector nozzle comprising the fourth material and further comprising a plurality of through holes.
2. The method of embodiment 1, wherein the third material is different than the first and second materials.
3. The method of embodiment 1, wherein the third material is the same material as the second material.
4. The method of embodiment 1, wherein the fourth material is the same material as the third material.
5. The method of embodiment 1, wherein the fourth material is different than the first, second and third materials.
6. The method of any one of embodiments 1 to 5, wherein the replicating the first microstructured pattern in a second material comprises electroforming the first microstructured pattern.
7. The method of embodiment 6, wherein the second material comprises nickel or a nickel alloy.
8. The method of any one of embodiments 1 to 7, wherein the fourth material comprises a polymer.
9. The method of any one of embodiments 1 to 7, wherein the fourth material comprises a metal.
10. The method of any one of embodiments 1 to 7, wherein the fourth material comprises a ceramic.
11. The method of any one of embodiments 1 to 10, wherein the first material comprises poly(methylmethacrylate).
12. The method of any one of embodiments 1 to 10, wherein the first material is capable of undergoing a two photon reaction.
13. The method of embodiment 12, wherein the two photon reaction comprises simultaneous two photon absorption.
14. The method of any one of embodiments 1 to 13, wherein the microstructures comprise three-dimensional rectilinear bodies.
15. The method of any one of embodiments 1 to 13, wherein the microstructures comprises three-dimensional curvilinear bodies.
16. The method of any one of embodiments 1 to 15, further comprising removing a remaining portion of the fourth material of the fuel injector nozzle to open the plurality of through holes.
17. The method of embodiment 16, wherein removing the remaining portion is accomplished by backside grinding.
18. The method of embodiment 16, wherein removing the remaining portion is accomplished by EDM.
19. The method of any one of embodiments 1 to 18, further comprising debinding the fuel injector nozzle.
20. The method of any one of embodiments 1 to 19, further comprising sintering the fuel injector nozzle.
21. The method of any one of embodiments 1 to 20, further comprising applying a metal to a surface of the fuel injector nozzle.
22. A method of making a fuel injector nozzle, comprising:

providing a first material capable of undergoing multiphoton reaction;

forming a first microstructured pattern in the first material using a multiphoton process;

replicating the first microstructured pattern in a second material different than the first material to make a mold comprising a second microstructured pattern comprising a plurality of microstructures in the second material;

positioning a plate above the mold proximate the peaks of the plurality of microstructures in the second material;

injection molding a third material in the area above the mold surrounding the second microstructured pattern and below the plate; and

removing the plate and mold, resulting in a fuel injector nozzle comprising the third material and further comprising a plurality of through holes.
23. The method of embodiment 22, wherein the third material is different than the first and second materials.
24. The method of embodiment 22, wherein the third material is the same material as the second material.
25. The method of embodiment 22, further comprising removing a remaining portion of the third material of the fuel injector nozzle to open the plurality of through holes.
26. The method of embodiment 25, wherein removing the remaining portion is accomplished by backside grinding.
27. The method of embodiment 25, wherein removing the remaining portion is accomplished by EDM.
28. The method of any one of embodiments 22 to 27, further comprising debinding the fuel injector nozzle.
29. The method of any one of embodiments 22 to 28, further comprising sintering the fuel injector nozzle.
30. The method of any one of embodiments 22 to 29, further comprising applying a metal to a surface of the fuel injector nozzle.
31. A method of making a fuel injector nozzle, comprising:

forming a mold by creating a microstructured pattern in a first material, the first microstructured pattern comprising a plurality of microstructures;

positioning a plate above the mold proximate the peaks of the plurality of microstructures in the first material;

injection molding a second material different than the first material in the area above the mold surrounding the microstructured pattern and below the plate; and

removing the plate and mold, resulting in a fuel injector nozzle comprising the second material and further comprising a plurality of through holes.
32. The method of embodiment 31, wherein creating a microstructured pattern is accomplished by end milling.
33. The method of embodiment 31 or 32, wherein creating a microstructured pattern is accomplished by grinding.
34. The method of any one of embodiments 31 to 33, wherein creating a microstructured pattern is accomplished by EDM.
35. The method of any one of embodiments 31 to 34, further comprising removing a remaining portion of the second material of the fuel injector nozzle to open the plurality of through holes.
36. The method of embodiment 35, wherein removing the remaining portion is accomplished by backside grinding.
37. The method of embodiment 35, wherein removing the remaining portion is accomplished by EDM.
38. The method of any one of embodiments 31 to 37, further comprising debinding the fuel injector nozzle.
39. The method of any one of embodiments 31 to 38, further comprising sintering the fuel injector nozzle.
40. The method of any one of embodiments 31 to 39, further comprising applying a metal to a surface of the fuel injector nozzle.
41. A method of making a fuel injector nozzle, comprising:

providing a first material capable of undergoing multiphoton reaction;

forming a first microstructured pattern in the first material using a multiphoton process;

replicating the first microstructured pattern in a second material different than the first material to make a first tool comprising a second microstructured pattern in the second material;

using the tool to form a third microstructured pattern comprising a plurality of microstructures that is the inverse of the second microstructured pattern in a metallic substrate to create a mold;

positioning a plate above the second mold proximate the peaks of the plurality of microstructures in the metallic substrate;

injection molding a third material in the area above the mold surrounding the third microstructured pattern and below the plate; and

removing the plate and mold, resulting in a fuel injector nozzle comprising the third material and further comprising a plurality of through holes.
42. The method of embodiment 41, wherein the tool is an electrode.
43. The method of embodiment 41 or 42, wherein the tool forms a third microstructured pattern in a metallic substrate by EDM.
44. The method of any one of embodiments 41 to 43, further comprising removing a remaining portion of the third material of the fuel injector nozzle to open the plurality of through holes.
45. The method of embodiment 44, wherein removing the remaining portion is accomplished by backside grinding.
46. The method of embodiment 44, wherein removing the remaining portion is accomplished by EDM.
47. The method of any one of embodiments 41 to 46, further comprising debinding the fuel injector nozzle.
48. The method of any one of embodiments 41 to 47, further comprising sintering the fuel injector nozzle.
49. The method of any one of embodiments 41 to 48, further comprising applying a metal to a surface of the fuel injector nozzle.

All U.S. patents and patent applications cited in the present description (except those cited to clarify the definition of nozzle as used herein) are incorporated by reference as if fully set forth. The present invention should not be considered limited to the particular examples and embodiments described above, as such embodiments are described in detail in order to facilitate explanation of various aspects of the invention. Rather, the present invention should be understood to cover all aspects of the invention, including various modifications, equivalent processes, and alternative devices falling within the scope of the invention as defined by the appended claims and their equivalents.

1. A method of making a fuel injector nozzle, comprising:
providing a first material capable of undergoing multiphoton reaction;
forming a first microstructured pattern in the first material using a multiphoton process;
replicating the first microstructured pattern in a second material different than the first material to make a first mold comprising a second microstructured pattern in the second material;
replicating the second microstructured pattern in a third material to make a second mold comprising a third microstructured pattern comprising a plurality of microstructures in the third material;
positioning a plate above the second mold proximate the peaks of the plurality of microstructures in the third material;
injection molding a fourth material in the area above the second mold surrounding the third microstructured pattern and below the plate; and
removing the plate and second mold, resulting in a fuel injector nozzle comprising the fourth material and further comprising a plurality of through holes.

2. The method of claim 1, wherein the fourth material is the same material as the third material, or the fourth material is different than the first, second and third materials.

3. The method of claim 1, wherein the replicating the first microstructured pattern in a second material comprises electroforming the first microstructured pattern.

4. The method of claim 3, wherein the second material comprises nickel or a nickel alloy.

5. The method of claim 1, wherein the fourth material comprises a polymer, a metal, a ceramic or any combination thereof.

6. (canceled)

7. (canceled)

8. (canceled)

9. The method of claim 1, wherein the microstructures comprise three-dimensional rectilinear bodies, three-dimensional curvilinear bodies, or a combination thereof.

10. The method of claim 1, further comprising removing a remaining portion of the fourth material of the fuel injector nozzle to open the plurality of through holes.

11. A method of making a fuel injector nozzle, comprising:
providing a first material capable of undergoing multiphoton reaction;
forming a first microstructured pattern in the first material using a multiphoton process;
replicating the first microstructured pattern in a second material different than the first material to make a mold comprising a second microstructured pattern comprising a plurality of microstructures in the second material;
positioning a plate above the mold proximate the peaks of the plurality of microstructures in the second material;
injection molding a third material in the area above the mold surrounding the second microstructured pattern and below the plate; and
removing the plate and mold, resulting in a fuel injector nozzle comprising the third material and further comprising a plurality of through holes.

12. The method of claim 11, wherein the third material is different than the first and second materials, or the third material is the same material as the second material.

13. The method of claim 11, further comprising removing a remaining portion of the third material of the fuel injector nozzle to open the plurality of through holes.

14. A method of making a fuel injector nozzle, comprising:
forming a mold by creating a microstructured pattern in a first material, the first microstructured pattern comprising a plurality of microstructures;
positioning a plate above the mold proximate the peaks of the plurality of microstructures in the first material;
injection molding a second material different than the first material in the area above the mold surrounding the microstructured pattern and below the plate; and
removing the plate and mold, resulting in a fuel injector nozzle comprising the second material and further comprising a plurality of through holes.

15. The method of claim 14, wherein creating a microstructured pattern is accomplished by end milling, grinding, EDM, or any combination thereof.

16. The method of claim 14, further comprising removing a remaining portion of the second material of the fuel injector nozzle to open the plurality of through holes.

17. A method of making a fuel injector nozzle, comprising:
providing a first material capable of undergoing multiphoton reaction;
forming a first microstructured pattern in the first material using a multiphoton process;
replicating the first microstructured pattern in a second material different than the first material to make a first tool comprising a second microstructured pattern in the second material;
using the tool to form a third microstructured pattern comprising a plurality of microstructures that is the inverse of the second microstructured pattern in a metallic substrate to create a mold;
positioning a plate above the second mold proximate the peaks of the plurality of microstructures in the metallic substrate;
injection molding a third material in the area above the mold surrounding the third microstructured pattern and below the plate; and
removing the plate and mold, resulting in a fuel injector nozzle comprising the third material and further comprising a plurality of through holes.

18. The method of claim 17, wherein the tool is an electrode.

19. The method of claim 17, wherein the tool forms a third microstructured pattern in a metallic substrate by EDM.

20. The method of claim 17, further comprising removing a remaining portion of the third material of the fuel injector nozzle to open the plurality of through holes.

21. The method of claim 10, wherein removing the remaining portion is accomplished by backside EDM.

22. The method of claim 1, further comprising debinding the fuel injector nozzle, sintering the fuel injector nozzle, applying a metal to a surface of the fuel injector nozzle, or any combination thereof.

23. The method of claim 11, wherein the third material comprises a metal, a ceramic or a combination thereof.
